(19) United States
(12) Patent Application Publication
(10) Pub. No.: US 2025/0133028 A1
(43) Pub. Date: Apr. 24, 2025

(54) NOTIFYING A VIRTUAL GATEWAY OF QOS TREATMENT FOR A COMPUTING DEVICE CONNECTING TO A LOCAL AREA NETWORK

(71) Applicant: Charter Communications Operating, LLC, St. Louis, MO (US)

(72) Inventor: Timothy Clark Bleidorn, Colorado Springs, CO (US)

(21) Appl. No.: 18/493,349

(22) Filed: Oct. 24, 2023

(51) Int. Cl. H04L 47/24; H04L 47/10; H04L 61/5014; H04L 61/5038

(52) U.S. Cl. CPC H04L 47/2458; H04L 47/13; H04L 61/5014; H04L 61/5038

(57) ABSTRACT

A bridged gateway coupled to a local area network (LAN) in a premises establishes a layer 2 tunnel with a first computing device that is external to the LAN. The first computing device is operable to provide a virtual gateway that provides default gateway functionality to computing devices connected to the LAN. The bridged gateway receives from a second computing device connected to the LAN a first dynamic host configuration protocol (DHCP) Discover message. The bridged gateway determines that the second computing device is to be given a different quality of service (QOS) treatment that differs from a default QOS treatment associated with the LAN. The bridged gateway modifies the first DHCP Discover message to include a QOS special treatment indicator to generate a modified DHCP Discover message, and sends, to the first computing device via the layer 2 tunnel, the modified DHCP Discover message.

### BACKGROUND

It can be desirable for a service provider to move functionality conventionally provided by a router in a subscriber's home to the service provider's network for a variety of reasons, including, for example, to reduce a need to send a technician to a customer premises to diagnose and correct issues, facilitate faster problem resolution, and simplify introducing new features.

### SUMMARY

The examples disclosed herein notify a virtual gateway of quality of service treatment for a computing device connecting to a local area network

In one implementation a method is provided. The method includes establishing, by a bridged gateway coupled to a local area network (LAN) in a premises, a layer 2 tunnel with a first computing device that is external to the LAN, the first computing device operable to provide a virtual gateway that provides default gateway functionality to computing devices connected to the LAN. The method further includes receiving, by the bridged gateway from a second computing device connected to the LAN, a first dynamic host configuration protocol (DHCP) Discover message. The method further includes determining, by the bridged gateway, that the second computing device is to be given a different quality of service (QOS) treatment that differs from a default QOS treatment associated with the LAN. The method further includes modifying, by the bridged gateway, the first DHCP Discover message to include a QOS special treatment indicator to generate a modified DHCP Discover message, and sending, by the bridged gateway to the first computing device via the layer 2 tunnel, the modified DHCP Discover message.

In another implementation a bridged gateway is provided. The bridged gateway includes a memory, a transceiver operable to be coupled to a local area network (LAN), and a processor device coupled to the memory and the transceiver and being operable to establish a layer 2 tunnel with a first computing device that is external to the LAN, the first computing device operable to provide a virtual gateway that provides default gateway functionality to computing devices connected to the LAN. The processor device is further operable to receive, from a second computing device connected to the LAN, a first dynamic host configuration protocol (DHCP) Discover message. The processor device is further operable to determine that the second computing device is to be given a different quality of service (QOS) treatment that differs from a default QOS treatment associated with the LAN. The processor device is further operable to modify the first DHCP Discover message to include a QOS special treatment indicator to generate a modified DHCP Discover message. The processor device is further operable to send, to the first computing device via the layer 2 tunnel, the modified DHCP Discover message.

In another implementation a non-transitory computer-readable storage medium is provided. The non-transitory computer-readable storage medium includes executable instructions operable to cause a processor device coupled to a local area network (LAN) to establish a layer 2 tunnel with a first computing device that is external to the LAN, the first computing device operable to provide a virtual gateway that provides default gateway functionality to computing devices connected to the LAN. The instructions are further operable to cause the processor device to receive, from a second computing device connected to the LAN, a first dynamic host configuration protocol (DHCP) Discover message. The instructions are further operable to cause the processor device to determine that the second computing device is to be given a different quality of service (QOS) treatment that differs from a default QOS treatment associated with the LAN. The instructions are further operable to cause the processor device to modify the first DHCP Discover message to include a QOS special treatment indicator to generate a modified DHCP Discover message. The instructions are further operable to cause the processor device to send, to the first computing device via the layer 2 tunnel, the modified DHCP Discover message.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for notifying a virtual gateway of quality of service (QOS) treatment for a computing device connecting to a LAN according to one implementation;

FIG. 2 is a flowchart of a method for notifying a virtual gateway of QOS treatment for a computing device connecting to a LAN according to one implementation;

FIGS. 3A-3B illustrate a sequence diagram illustrating messages communicated between and actions taken by certain components illustrated in FIG. 1 to implement notifying a virtual gateway of QOS treatment for a computing device connecting to a LAN according to one implementation; and

FIG. 4 is a block diagram of a bridged gateway suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Devices connected to a local area network (LAN) typically communicate with other devices connected to the same LAN via layer 2 communication protocols, and with devices connected to another LAN via layer 3 communication protocols. Layer 3 protocol communications are facilitated via a gateway router that is typically physically connected to the same LAN and also connected to another network, such as a network of a service provider that provides broadband access to the entity operating the LAN. The gateway router implements traditional gateway router services, such as dynamic host configuration protocol (DHCP) services for providing network-connected computing devices with internet protocol (IP) addresses as needed, network address translation (NAT) services to translate private IP addresses associated with a subnetwork to a public IP address, Domain Name System (DNS) services for translating a domain name to an IP address, and the like.

A service provider may desire to provide gateway router functionality from a location within the service provider's network rather than from the customer premises. Moving the gateway functionality from the subscriber's physical location to a network gateway router at a service provider's location, sometimes referred to as a “virtual gateway”, may make it easier to support customer issues and reduce the need to send a technician to a customer premises such as a home or business. Virtual gateways may be implemented on computing device in the service provider's network, such as, by way of non-limiting example, a broadband network gateway (BNG). A BNG may implement multiple virtual gateways, each of which provides default gateway router functionality to a particular customer LAN.

The terms subnetwork, or subnet, will be treated synonymously herein, and refer to a data communications network, often but not necessarily an Ethernet network, wherein each connected computing device on the subnet has an IP address that has the same network address, and which utilizes the same subnet mask to determine whether other computing devices are on the same network or are on a different network. Such computing devices may be referred to herein as being “on” or “connected to” or “coupled to” the same subnet. Computing devices on the same subnet can communicate with one another, typically via layer 2 addressing, such as a media access control (MAC) address, without the need for a router. A LAN is an example of a subnet.

Since a virtual gateway is not physically directly connected to the LAN in the same manner as a conventional gateway router, to implement a virtual gateway in a manner that is transparent to devices connected to the LAN, a device on the LAN, such as a bridged gateway, may establish a logical subscriber link (LSL) between the bridged gateway and the BNG. The LSL is typically implemented as a layer 2 (over layer 3) tunnel between the bridged gateway and the BNG, such as, by way of non-limiting example, a GRE tunnel. The bridged gateway may send layer 2 frames generated by devices on the LAN to the virtual gateway (via the BNG) via the tunnel, and may receive layer 2 frames generated by the virtual gateway via the tunnel and send the layer 2 frames to a device or devices on the LAN. This is done transparently such that devices on the LAN are unaware that the virtual gateway is not actually directly connected to the same physical network as the devices on the LAN.

A service provider that offers access to the Internet to customers may, under certain circumstances, provide a particular computing device that is connected to a LAN a special quality of service (QOS) treatment that differs from a default QOS treatment associated with other computing devices connected to the LAN. For example, a customer may pay for a particular speed tier, such as a download bandwidth of 500 megabits per second (Mbps). The service provider provisions the appropriate equipment to limit the bandwidth to 500 Mbps. By default, computing devices connected to the LAN may then enjoy up to a 500 Mbps download speed. The service provider, as an incentive or for other reasons, may offer to provide mobile phones bought from the service provider a one gigabits per second (Gbps) bandwidth irrespective of the provisioned bandwidth of the LAN. When the customer connects their mobile phone to the LAN, the default gateway router detects and identifies the mobile phone as a computing device that is to receive a different QOS treatment (e.g., 1 Gbps bandwidth) than the default QOS treatment (e.g., 500 Mbps bandwidth) associated with the LAN, and takes the appropriate actions to provide the mobile phone with the different QOS treatment. Such actions may include signaling various upstream devices, such as a cable model termination system (CMTS) or other computing devices in the service provider's network that can treat packet flows associated with the mobile phone differently from packet flows of other computing devices connected to the LAN.

A virtual gateway may lack the functionality to identify computing devices that are to be given different QOS treatment. However, in order to implement a different QOS treatment of a LAN-connected computing device, the virtual gateway needs to know that the LAN-connected computing device is to be given the different QOS treatment so the virtual gateway can signal the appropriate components to provide the different QOS treatment for the computing device.

The examples disclosed herein notify a virtual gateway of QOS treatment for a computing device connecting to a LAN. A bridged gateway receives a DHCP Discover message from a computing device connected to the LAN. The bridged gateway determines that the computing device is to be given a different QOS treatment that differs from a default QOS treatment associated with the LAN. The bridged gateway modifies the DHCP Discover message to include a QOS special treatment indicator to generate a modified DHCP Discover message, and sends, to a computing device hosting the virtual gateway, the modified DHCP Discover message. The virtual gateway receives the modified DHCP Discover message and takes the appropriate actions to provide the computing device with the different QOS treatment.

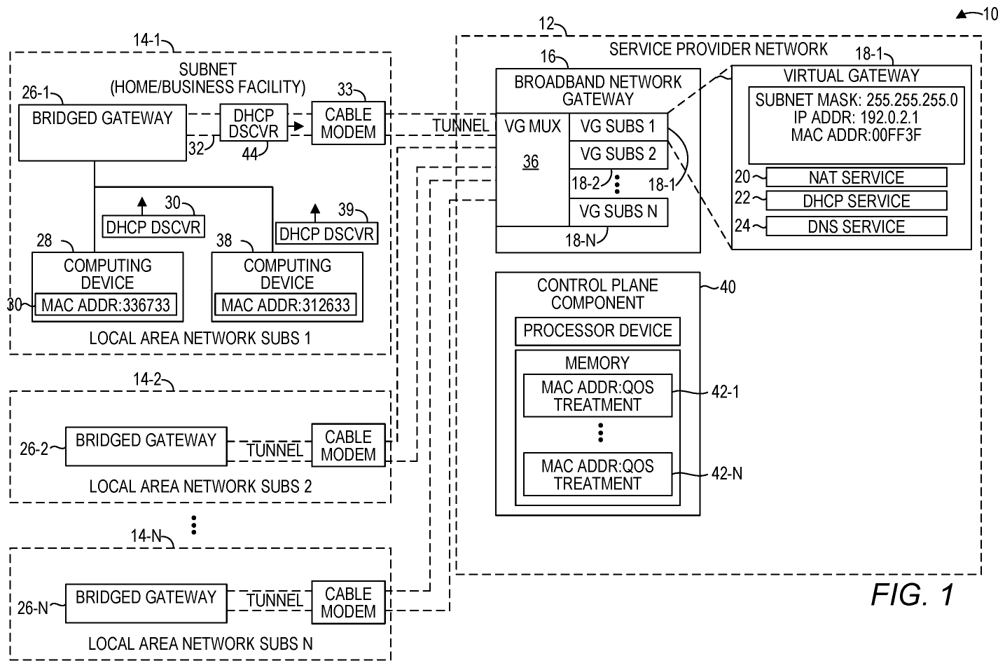

FIG. 1 is a block diagram of an environment 10 suitable for notifying a virtual gateway of QOS treatment for a computing device connecting to a LAN according to one implementation. The environment 10 includes a service provider network 12 and a plurality of local area networks (LANs) 14-1-14-N (generally, LANs 14), located in subscribers' premises, such as businesses or homes. The service provider network 12 includes a broadband network gateway (BNG) 16 that is a remote (e.g., on another network) computing device that is configured to initiate a plurality of virtual gateways 18-1-18-N (generally, virtual gateways 18) that provide, for the LANs 14-1-14-N, default gateway router functions, such as, by way of non-limiting example, a NAT service 20, a DHCP service 22, a DNS service 24, and a router function to facilitate communication between a computing device connected to a corresponding LAN 14 and a computing device connected to another network. The BNG 16 is physically located in a facility controlled by the respective service provider, and may be located tens, hundreds, or thousands of miles from the LANs 14. In some embodiments, the virtual gateways 18 may comprise a virtual gateway as described in TR-317 Network Enhanced Residential Gateway, available at www.broadband-forum.org/download/TR-317.pdf.

The LANs 14-1-14-N each have bridged gateways 26-1-26-N, respectively. The bridged gateway 26-1 is coupled to the LAN 14-1 via a layer 2 transceiver, such as an Ethernet wired transceiver, a Wi-Fi transceiver, or both. The bridged gateway 26-1 is a learning bridge and may serve as a Wi-Fi access point and/or a local Ethernet switch. The bridged gateway 26-1 also implements a transparent tunneling mechanism with the BNG 16 as will be described in greater detail below.

During an initialization stage of the bridged gateway 26-1, the bridged gateway 26-1 establishes a layer 2 (via layer 3) tunnel 32 with the BNG 16. It is noted that there may be one or more computing devices between the bridged gateway 26-1 and the BNG 16 such as, by way of non-limiting example, a cable modem 33 and a CMTS (not illustrated). The tunneling protocol may comprise any suitable tunneling protocol; however, in some embodiments, the tunneling protocol comprises a layer 2 tunneling protocol such as, by way of non-limiting example, the generic routing encapsulation (GRE) tunneling protocol. The bridged gateway 26-1 and the BNG 16 use their respective IP addresses to establish the layer 2 (over layer 3) tunnel. There may be any number of devices between the bridged gateway 26-1 and the BNG 16, such as, by way of non-limiting example, the cable modem 33 and one or more switching devices (not illustrated) in the service provider network 12.

At some point in time the computing device 28 connects to the LAN 14-1. The connection may be wireless or wired, such as via an ethernet cable. The connection process may be initiated in response to powering on the computing device 28, or, in the case of a Wi-Fi connection, by providing the appropriate authentication credentials to the bridged gateway 26-1 where the bridged gateway 26-1 also serves as a Wi-Fi access point.

The computing device 28 initiates a sequence to obtain an IP address and other information necessary to communicate with other computing devices. The sequence begins with the computing device 28 broadcasting a DHCP Discover message 30 (e.g., transmitting the DHCP Discover message to a broadcast destination address). The bridged gateway 26-1 receives the DHCP Discover message 30. The bridged gateway 26-1 analyzes the DHCP Discover message 30 and determines that the DHCP Discover message is a DHCP Discover message.

The bridged gateway 26-1 determines that the computing device 28 is to be given a different QOS treatment that differs from a default QOS treatment associated with the LAN 14-1. In some implementations, the bridged gateway 26-1 may retain a list of computing devices that are to be given a different QOS treatment along with identifying information of the computing devices, such as MAC addresses. The bridged gateway 26-1 may extract the source MAC address of the computing device 28 from the DHCP Discover message, determine that the MAC address is on the list, and thereby determine that the computing device 28 is to be given the different QOS treatment.

In another implementation, the bridged gateway 26-1 may interact with another computing device that is external to the LAN 14-1, in this example a control plane component 40, to determine whether the computing device 28 is to be given the different QOS treatment. In one example, the bridged gateway 26-1 sends information that identifies the computing device 28, such as the MAC address of the computing device 28 or any other suitable device identifier, to the control plane component 40. Note that the bridged gateway 26-1 and the control plane component 40 may communicate over a path other than the layer 2 tunnel 32.

The control plane component 40 receives the information that identifies the computing device 28. The control plane component 40 accesses a record 42-1 of a plurality records 42-1-42-N (generally, records 42), at least some of the plurality of records 42 corresponding to different computing devices associated with different LANS 14, the record 42-1 corresponding to the computing device 28. The records 42 identify whether a particular computing device is to be given a different QOS treatment than a default QOS treatment of the LAN 14 to which the particular computing device has connected. While for purposes of illustration the records 42 are illustrated as being hosted by the control plane component 40, in other implementations the control plane component 40 may communicate with another computing device in the service provider network 12 to obtain the record 42-1.

The control plane component 40 determines, based on the record 42-1, that the computing device 28 is to be given a different QOS treatment from the default QOS treatment of the LAN 14-1. The different QOS treatment can be any processing that enhances or decreases the QOS (i.e., latency, bandwidth, jitter, or the like) compared to any other computing device connected to the LAN 14-1 that does not also have a different QOS treatment. By way of non-limiting example, the QOS treatment may be that the computing device 28 receives a higher bandwidth than a provisioned service tier bandwidth of the LAN 14-1. The QOS treatment may be that the computing device 28 is given a lower latency queue than a default latency queue used by other computing devices connected to the LAN 14-1. The QOS treatment may be that the computing device 28 is given a larger memory buffer than a default buffer associated with the LAN 14-1, or that the computing device 28 is given a custom path through the service provider network 12 that is different from a default path through the service provider network 12. The QOS treatment may be that packets originating from or destined to the computing device 28 have a higher priority than any other packets associated with the LAN 14-1.

The control plane component 40 sends a message to the bridged gateway 26-1 that the computing device 28 is to be given the different QOS treatment. The message may indicate only that the computing device 28 is to be given the different QOS treatment, or may also indicate the particular different QOS treatment that the computing device 28 is to be given. The bridged gateway 26-1 receives, from the control plane component 40, the message indicating that the computing device 28 is to be given the different QOS treatment. The bridged gateway 26-1 modifies the DHCP Discover message to include a QOS special treatment indicator to generate a modified DHCP Discover message 44. The QOS special treatment indicator can comprise any data that the virtual gateway 18-1 has been programmed to recognize as indicating that the computing device 28 is to be given the different QOS treatment. In some implementations, the QOS special treatment indicator may be conveyed as DHCP option 82 information (sometimes referred to as the “relay agent information option”). The bridged gateway 26-1 sends, to the BNG 16 via the layer 2 tunnel, the modified DHCP Discover message 44.

A virtual gateway multiplexer 36 determines that the virtual gateway 18-1 provides default gateway services for the LAN 14-1, and sends the modified DHCP Discover message 44 to the virtual gateway 18-1 for processing. The virtual gateway 18-1 receives the modified DHCP discover message 44. The virtual gateway 18-1 determines, based on the QOS special treatment indicator in the modified DHCP discover message 44, that the computing device 28 is to be given the different QOS treatment. The QOS special treatment indicator may indicate the particular QOS treatment that the computing device 28 is to be given, or the virtual gateway 18-1 may otherwise determine the particular QOS treatment, such as by communicating with another computing device in the service provider network 12 that maintains such information.

The virtual gateway 18-1 may store information that indicates that the computing device 28 is to be given the different QOS treatment. Depending on the particular QOS treatment, the virtual gateway 18-1 may take the appropriate actions, such as storing suitable information or sending messages to other computing devices in the service provider network 12 that will cause the computing device 28 to receive the particular QOS treatment.

The virtual gateway 18-1 then generates a DHCP Offer message. The BNG 16 encapsulates the DHCP Offer message into a layer 3 protocol, such as TCP/IP, and sends the DHCP Offer message to the bridged gateway 26-1 via the tunnel 32. The bridged gateway 26-1 extracts the DHCP Offer message from the layer 3 protocol and sends the DHCP Offer message to the computing device 28 using the MAC address of the virtual gateway 18-1 as the originator of the layer 2 frame. The computing device 28 receives the DHCP Offer message, and the computing device 28 and virtual gateway 18-1 finalize the four message DHCP sequence (e.g., Discover, Offer, Request, Ack). At the end of the sequence the computing device 28 has an IP address and a subnet mask that the computing device 28 uses to determine if an IP address of a destination device is on the LAN 14-1 or is on another network.

Subsequently, assume that the computing device 28 desires to send a packet to a computing device that is not on the LAN 14-1. The computing device 28 addresses the packet to the virtual gateway 18-1 using the MAC address of the virtual gateway 18-1 because the virtual gateway 18-1 identified itself to the computing device 28 as the default gateway router for the computing device 28 during the DHCP process.

The bridged gateway 26-1 receives the packet, determines that the packet is addressed to the virtual gateway 18-1, encapsulates the packet in the layer 3 protocol and sends the packet to the BNG 16 via the tunnel 32. The virtual gateway multiplexer 36 receives the packet, determines that the packet is destined for the virtual gateway 18-1, and sends the packet to the virtual gateway 18-1. The virtual gateway 18-1 may then access the information that the virtual gateway 18-1 previously stored that indicates that the computing device 28 is to be given the different QOS treatment. The virtual gateway 18-1 may cause the computing device 28 to receive the different QOS treatment. For example, the virtual gateway 18-1 may perform processing that causes a packet flow between the computing device 28 and the computing device to which the packet is addressed to have a higher bandwidth than a service tier bandwidth of the LAN. For example, the packet may be addressed to a streaming service, and the packet flow between the streaming service and the computing device 28 may enjoy a 1 Gbps streaming rate even though the LAN 14-1 has been provisioned for a default 500 Mbps rate. The processing may include informing other computing devices, such as, by way of non-limiting example, a CMTS or other aggregation device to which the cable modem 33 is communicatively coupled, that the CMTS is to provide the computing device 28 a one Gpbs streaming rate. The virtual gateway 18-1 forwards the packet from the computing device 28 to a router based on routing tables maintained by the virtual gateway 18-1 in the same manner as a conventional gateway router.

The bridged gateway 26-1 forwards all layer 2 frames generated by a computing device 28 on the LAN 14-1 that have a destination address of the virtual gateway 18-1 and all broadcast layer 2 frames to the virtual gateway 18-1. To the computing device 28, the virtual gateway 18-1 appears to be directly coupled to the LAN 14-1. The bridged gateways 26-2-26-N operate substantially similarly to the bridged gateway 26-1.

For purposes of illustration assume that another computing device 38 connects to the LAN 14-1. The computing device 38 initiates a sequence to obtain an IP address and other information necessary to communicate with other computing devices. The sequence begins with the computing device 38 broadcasting a DHCP Discover message 39. The bridged gateway 26-1 receives the DHCP Discover message 39. The bridged gateway 26-1 analyzes the DHCP Discover message 39 and determines that the first DHCP Discover message is a DHCP Discover message. The bridged gateway 26-1 determines that the computing device 38 is not to be given a different QOS treatment that differs from a default QOS treatment associated with the LAN 14-1. For example, the bridged gateway 26-1 sends information that identifies the computing device 38, such as the MAC address of the computing device 38 to the control plane component 40.

The control plane component 40 receives the information that identifies the computing device 38. The control plane component 40 accesses the records 42 and determines that none of the records 42 correspond to the computing device 38. The control plane component 40 sends a message to the bridged gateway 26-1 that indicates that the computing device 38 is not to be given a different QOS treatment that differs from a default QOS treatment associated with the LAN 14-1. The bridged gateway 26-1 inhibits modifying the DHCP Discover message 39, and sends, to the BNG 16 via the layer 2 tunnel, the DHCP Discover message 39.

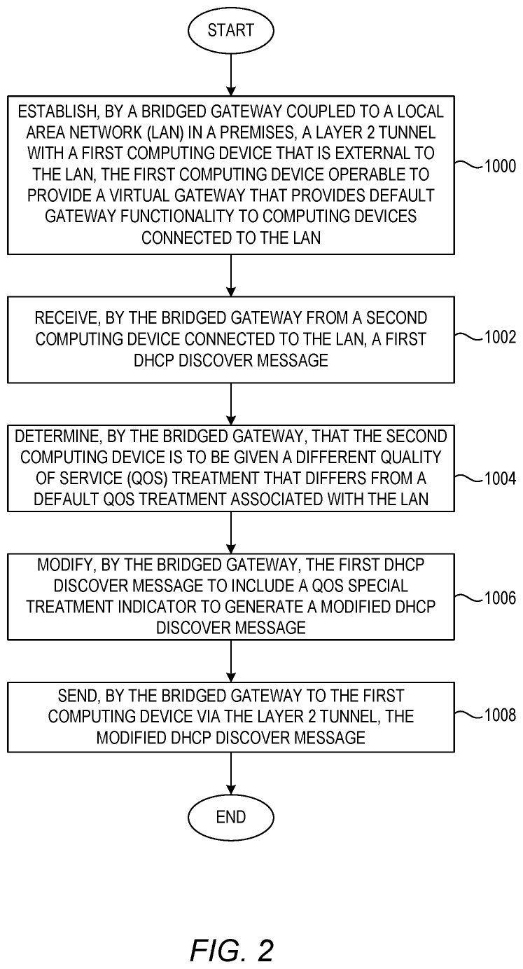

FIG. 2 is a flowchart of a method for notifying a virtual gateway of QOS treatment for a computing device connecting to a LAN according to one implementation. FIG. 2 will be discussed in conjunction with FIG. 1. The bridged gateway 26-1, coupled to the LAN 14-1 in a premises, established the layer 2 tunnel 32 with a computing device such as the BNG 16 that is external to the LAN 14-1. The BNG 16 is operable to provide the virtual gateway 18-1 that provides default gateway functionality to computing devices connected to the LAN 14-1 (FIG. 2, block 1000). The bridged gateway 26-1 receives, from the computing device 28 connected to the LAN 14-1, the DHCP Discover message 30 (FIG. 2, block 1002). The bridged gateway 26-1 determines that the computing device 28 is to be given a different QOS treatment that differs from a default QOS treatment associated with the LAN 14-1 (FIG. 2, block 1004).

The bridged gateway 26-1 modifies the DHCP Discover message 30 to include a QOS special treatment indicator to generate the modified DHCP Discover message 44 (FIG. 2, block 1006). The bridged gateway 26-1 sends, to the BNG 16 via the layer 2 tunnel 32 the modified DHCP Discover message 44 (FIG. 2, block 1008).

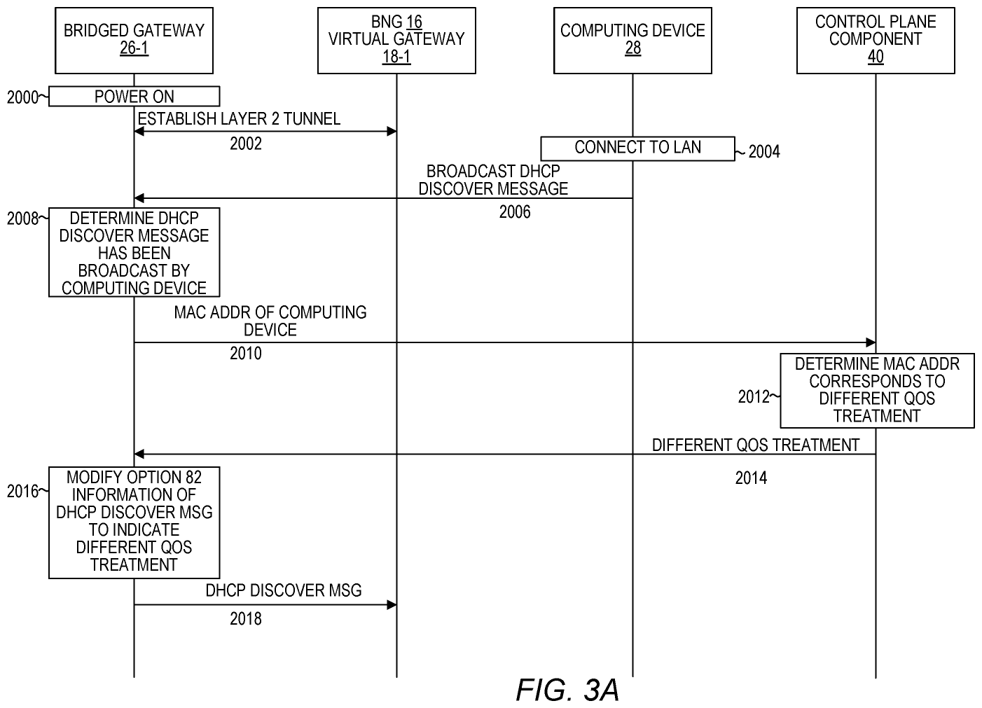

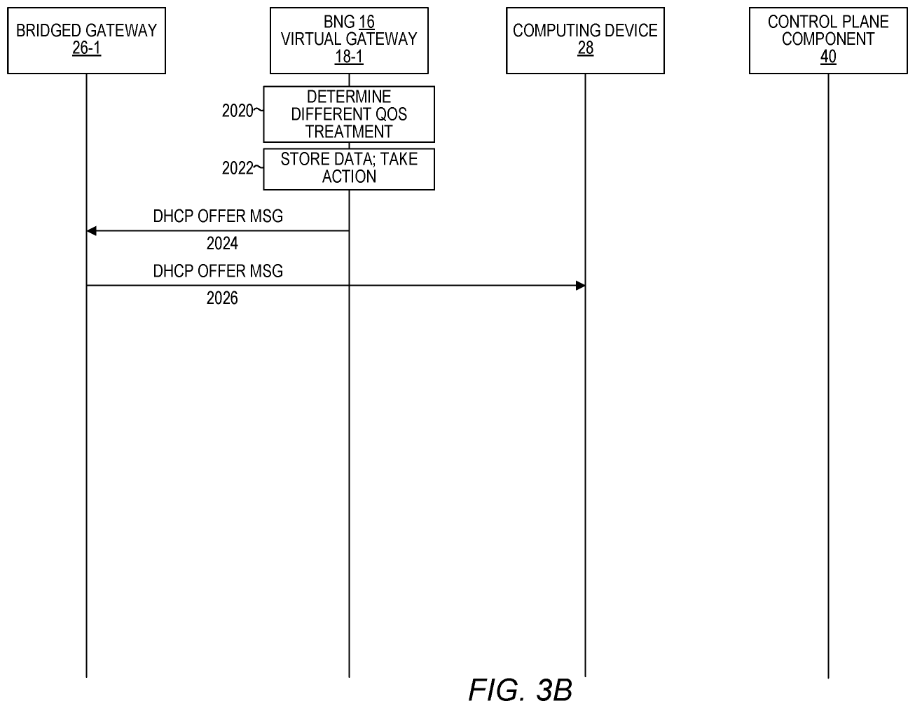

FIGS. 3A-3B illustrate a sequence diagram illustrating messages communicated between and actions taken by certain components illustrated in FIG. 1 to implement notifying a virtual gateway of QOS treatment for a computing device connecting to a LAN according to one implementation. The bridged gateway 26-1 is powered on (FIG. 3A, step 2000). During the initialization phase, the bridged gateway 26-1 establishes a layer 2 tunnel with the BNG 16 which is on a different network than the bridged gateway 26-1 (FIG. 3A, step 2002). The computing device 28 connects to the LAN 14-1 (FIG. 3A, step 2004). The computing device 28 broadcasts a DHCP Discover message 30 (FIG. 3A, step 2006). The bridged gateway 26-1 receives the DHCP Discover message, analyzes the DHCP Discover message 30 and determines that the DHCP Discover message is a DHCP Discover message (FIG. 3A, step 2008).

The bridged gateway 26-1 determines that the computing device 28 is to be given a different QOS treatment that differs from a default QOS treatment associated with the LAN 14-1. In this implementation, the bridged gateway 26-1 extracts the source MAC address of the computing device 28 from the DHCP Discover message, and sends the source MAC address that identifies the computing device 28 to the control plane component 40 (FIG. 3A, step 2010).

The control plane component 40 receives the information that identifies the computing device 28. The control plane component 40 accesses the record 42-1 of the plurality records 42-1-42-N and determines that the record 42-1 corresponds to the computing device 28 (FIG. 3A, step 2012). The control plane component 40 determines, based on the record 42-1, that the computing device 28 is to be given a different QOS treatment from the default QOS treatment of the LAN 14-1. The control plane component 40 sends a message to the bridged gateway 26-1 that the computing device 28 is to be given the different QOS treatment (FIG. 3A, step 2014).

The bridged gateway 26-1 receives, from the control plane component 40, the message indicating that the computing device 28 is to be given the different QOS treatment. The bridged gateway 26-1 modifies the DHCP Discover message to include a QOS special treatment indicator to generate a modified DHCP Discover message 44 (FIG. 3A, step 2016). The bridged gateway 26-1 sends, to the BNG 16 via the layer 2 tunnel, the modified DHCP Discover message (FIG. 3A, step 2028).

Referring now to FIG. 3B, the virtual gateway multiplexer 36 determines that the virtual gateway 18-1 provides default gateway services for the LAN 14-1, and sends the modified DHCP Discover message 44 to the virtual gateway 18-1 for processing. The virtual gateway 18-1 receives the modified DHCP discover message 44. The virtual gateway 18-1 determines, based on the QOS special treatment indicator in the modified DHCP discover message 44, that the computing device 28 is to be given the different QOS treatment (FIG. 3B, step 2020).

The virtual gateway 18-1 may store information that indicates that the computing device 28 is to be given the different QOS treatment and/or take other appropriate actions, that will cause the computing device 28 to receive the particular QOS treatment (FIG. 3B, step 2022). The virtual gateway 18-1 then generates a DHCP Offer message and sends the DHCP Offer message to the bridged gateway 26-1 via the tunnel 32 (FIG. 3B, step 2024). The bridged gateway 26-1 extracts the DHCP Offer message from the layer 3 protocol and sends the DHCP Offer message to the computing device 28 using the MAC address of the virtual gateway 18-1 as the originator of the layer 2 frame (FIG. 3B, step 2026). The computing device 28 receives the DHCP Offer message, and the computing device 28 and virtual gateway 18-1 finalize the four message DHCP sequence.

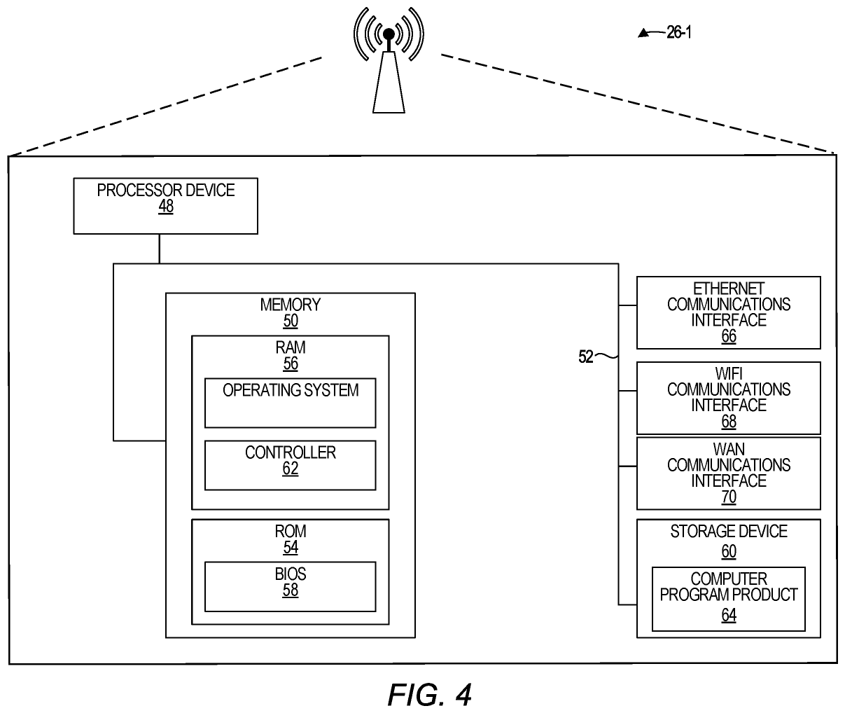

FIG. 4 is a block diagram of the bridged gateway 26-1 suitable for implementing examples disclosed herein. The bridged gateway 26-1 may comprise a learning bridge and Wi-Fi access point. The bridged gateway 26-1 includes a processor device 48, a system memory 50, and a system bus 52. The system bus 52 provides an interface for system components including, but not limited to, the system memory 50 and the processor device 48. The processor device 48 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The system memory 50 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the bridged gateway 26-1. The volatile memory 56 may also include a high-speed RAM, such as static RAM, for caching data.

The bridged gateway 26-1 may further include or be coupled to a non-transitory computer-readable storage medium such as a storage device 60, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 60 and other drives associated with computer-readable media and computer-usable media may provide non-volatile storage of data, data structures, computer-executable instructions, and the like.

A number of modules can be stored in the storage device 60 and in the volatile memory 56, including an operating system and one or more program modules, such as a controller 62, which may implement the functionality described herein in whole or in part. All or a portion of the examples may be implemented as a computer program product 64 stored on a transitory or non-transitory computer-usable or computer-readable storage medium, such as the storage device 60, which includes complex programming instructions, such as complex computer-readable program code, to cause the processor device 48 to carry out the steps described herein. Thus, the computer-readable program code can comprise software instructions for implementing the functionality of the examples described herein when executed on the processor device 48. The processor device 48, in conjunction with the controller 62 in the volatile memory 56, may serve as a controller, or control system, for the bridged gateway 26-1 that is to implement the functionality described herein.

The bridged gateway 26-1 may have a number of communication interfaces including, for example, one or more ethernet communication interfaces 66 to which a computing device, such as the computing device 28, can be connected via an appropriate cable. The bridged gateway 26-1 may also serve as a Wi-Fi access point and have a Wi-Fi communication interface 68 via which computing devices can connect to the bridged gateway 26-1 wirelessly. The bridged gateway 26-1 includes a WAN interface 70 via which the bridged gateway 26-1 can communicate with a device associated with the service provider network 12, such as a cable or fiber modem, or the like, and which facilitates communications with, for example, the BNG 16.

Individuals will recognize improvements and modifications to the preferred examples of the disclosure. All such improvements and modifications are considered within the scope of the concepts disclosed herein and the claims that follow.

What is claimed is:

1. A method comprising:
establishing, by a bridged gateway coupled to a local area network (LAN) in a premises, a layer 2 tunnel with a first computing device that is external to the LAN, the first computing device operable to provide a virtual gateway that provides default gateway functionality to computing devices connected to the LAN;
receiving, by the bridged gateway from a second computing device connected to the LAN, a first dynamic host configuration protocol (DHCP) Discover message;
determining, by the bridged gateway, that the second computing device is to be given a different quality of service (QOS) treatment that differs from a default QOS treatment associated with the LAN;
modifying, by the bridged gateway, the first DHCP Discover message to include a QOS special treatment indicator to generate a modified DHCP Discover message; and
sending, by the bridged gateway to the first computing device via the layer 2 tunnel, the modified DHCP Discover message.

2. The method of claim 1 wherein determining that the second computing device is to be given the different QOS treatment comprises:
sending, by the bridged gateway to a control plane component that is external to the LAN, information that identifies the second computing device; and
receiving, by the bridged gateway from the control plan component, a message indicating that the second computing device is to be given the different QOS treatment.

3. The method of claim 2 wherein sending, by the bridged gateway to the control plane component that is external to the LAN, the information that identifies the second computing device comprises sending, by the bridged gateway to the control plane component via a path other than the layer 2 tunnel, the information that identifies the second computing device.

4. The method of claim 2 wherein the information comprises a MAC address of the second computing device.

5. The method of claim 2 further comprising:
receiving, by the control plane component, the information that identifies the second computing device;
accessing, by the control plane component, a first record of a plurality records, at least some of the plurality of records corresponding to different computing devices associated with different LANS, the first record corresponding to the second computing device; and
determining, by the control plane component based on the first record, that the second computing device is to be given the different QOS treatment.

6. The method of claim 1 further comprising:
analyzing, by the bridged gateway, the first DHCP Discover message to determine that the first DHCP Discover message is a DHCP Discover message.

7. The method of claim 1 wherein the different QOS treatment comprises one or more of a higher bandwidth than a service tier bandwidth of the LAN, use of a lower latency queue than a default latency queue associated with the LAN, a larger buffer than a default buffer associated with the LAN, and a custom path through a service provider network that is different from a default path through the service provider network.

8. The method of claim 1 further comprising:
receiving, by the virtual gateway, the modified DHCP discover message;
determining, by the virtual gateway based on the QOS special treatment indicator, that the second computing device is to be given the different QOS treatment; and
storing, by the virtual gateway, information that indicates that the second computing device is to be given the different QOS treatment.

9. The method of claim 8 further comprising:
subsequent to storing the information that indicates that the second computing device is to be given the different QOS treatment, receiving, by the virtual gateway via the layer 2 tunnel, a packet originating from the second computing device;
accessing the information that indicates that the second computing device is to be given the different QOS treatment; and
causing, by the virtual gateway, the second computing device to receive the different QOS treatment.

10. The method of claim 9 wherein causing, by the virtual gateway, the second computing device to receive the different QOS treatment comprises causing, by the virtual gateway, a packet flow between the second computing device and a third computing device to have a higher bandwidth than a service tier bandwidth of the LAN.

11. The method of claim 1 further comprising:
sending, by the virtual gateway to the second computing device via the layer 2 tunnel, a DHCP offer message.

12. The method of claim 1 further comprising:
receiving, by the bridged gateway from a third computing device connected to the LAN, a second DHCP Discover message;
determining, by the bridged gateway, that the third computing device is not to be given a different QOS treatment that differs from the default QOS treatment associated with the LAN;
inhibiting modifying the second DHCP Discover message; and
sending, by the bridged gateway to the first computing device via the layer 2 tunnel, the second DHCP Discover message.

13. A bridged gateway, comprising:
a memory;
a transceiver operable to be coupled to a local area network (LAN); and
a processor device coupled to the memory and the transceiver and being operable to:
establish a layer 2 tunnel with a first computing device that is external to the LAN, the first computing device operable to provide a virtual gateway that provides default gateway functionality to computing devices connected to the LAN;
receive, from a second computing device connected to the LAN, a first dynamic host configuration protocol (DHCP) Discover message;
determine that the second computing device is to be given a different quality of service (QOS) treatment that differs from a default QOS treatment associated with the LAN;
modify the first DHCP Discover message to include a QOS special treatment indicator to generate a modified DHCP Discover message; and
send, to the first computing device via the layer 2 tunnel, the modified DHCP Discover message.

14. The bridged gateway of claim 13 wherein to determine that the second computing device is to be given the different QOS treatment, the processor device is further operable to:
send, to a control plane component that is external to the LAN, information that identifies the second computing device; and
receive, from the control plan component, a message indicating that the second computing device is to be given the different QOS treatment.

15. The bridged gateway of claim 13 wherein the different QOS treatment comprises one or more of a higher bandwidth than a service tier bandwidth of the LAN, use of a lower latency queue than a default latency queue associated with the LAN, a larger buffer than a default buffer associated with the LAN, and a custom path through a service provider network that is different from a default path through the service provider network.

16. The bridged gateway of claim 13 wherein the processor device is further operable to:
receive, from a third computing device connected to the LAN, a second DHCP Discover message;
determine that the third computing device is not to be given a different QOS treatment that differs from the default QOS treatment associated with the LAN;
inhibit modifying the second DHCP Discover message; and
send, to the first computing device via the layer 2 tunnel, the second DHCP Discover message.

17. A non-transitory computer-readable storage medium that includes executable instructions operable to cause a processor device coupled to a local area network (LAN) to:
establish a layer 2 tunnel with a first computing device that is external to the LAN, the first computing device operable to provide a virtual gateway that provides default gateway functionality to computing devices connected to the LAN;
receive, from a second computing device connected to the LAN, a first dynamic host configuration protocol (DHCP) Discover message;
determine that the second computing device is to be given a different quality of service (QOS) treatment that differs from a default QOS treatment associated with the LAN;
modify the first DHCP Discover message to include a QOS special treatment indicator to generate a modified DHCP Discover message; and
send, to the first computing device via the layer 2 tunnel, the modified DHCP Discover message.

18. The non-transitory computer-readable storage medium of claim 17 wherein to determine that the second computing device is to be given the different QOS treatment, the instructions are further operable to cause the processor device to:
send, to a control plane component that is external to the LAN, information that identifies the second computing device; and
receive, from the control plan component, a message indicating that the second computing device is to be given the different QOS treatment.

19. The non-transitory computer-readable storage medium of claim 17 wherein the different QOS treatment comprises one or more of a higher bandwidth than a service tier bandwidth of the LAN, use of a lower latency queue than a default latency queue associated with the LAN, a larger buffer than a default buffer associated with the LAN, and a custom path through a service provider network that is different from a default path through the service provider network.

20. The non-transitory computer-readable storage medium of claim 17 wherein the instructions are further operable to cause the processor device to:
receive, from a third computing device connected to the LAN, a second DHCP Discover message;
determine that the third computing device is not to be given a different QOS treatment that differs from the default QOS treatment associated with the LAN;
inhibit modifying the second DHCP Discover message; and
send, to the first computing device via the layer 2 tunnel, the second DHCP Discover message.
